(19) United States
(12) Patent Application Publication
(10) Pub. No.: US 2026/0128501 A1
(43) Pub. Date: May 7, 2026

(54) ELECTRONIC DEVICE INCLUDING ANTENNA

(71) Applicant: Samsung Electronics Co., Ltd., Suwon-si (KR)

(72) Inventors: Sungkoo PARK, Suwon-si (KR); Sewoong KIM, Suwon-si (KR); Haeyeon KIM, Suwon-si (KR); Hojung NAM, Suwon-si (KR); Kyungjae LEE, Suwon-si (KR); Kookjoo LEE, Suwon-si (KR); Soonho HWANG, Suwon-si (KR)

(21) Appl. No.: 19/436,852

(22) Filed: Dec. 30, 2025

Related U.S. Application Data
(63) Continuation of application No. PCT/KR2024/007874, filed on Jun. 10, 2024.

(30) Foreign Application Priority Data
Jun. 30, 2023 (KR) 10-2023-0084949
Aug. 10, 2023 (KR) 10-2023-0104652

(51) Int. Cl. H01Q 1/22

(52) U.S. Cl. CPC H01Q 1/22

(57) ABSTRACT

An electronic device including an antenna is provided. A side member of the electronic device includes a first conductive portion, a second conductive portion, and a non-conductive portion disposed between the first conductive portion and the second conductive portion. The electronic device may comprise: the side member; a wireless communication circuit which is electrically connected to the first conductive portion and provides an RF signal of a designated frequency; and a first tuning unit which is electrically connected to the first conductive portion and the second conductive portion, wherein the first tuning unit includes: a variable capacitor which is electrically connected to the first conductive portion and the second conductive portion; and a plurality of switches for switching electrical connections between both ends of the variable capacitor and at least one lumped element.

### CROSS-REFERENCE TO RELATED APPLICATIONS

This application is a continuation of International Application No. PCT/KR2024/007874 designating the United States, filed on Jun. 10, 2024, in the Korean Intellectual Property Receiving Office and claiming priority to Korean Patent Application Nos. 10-2023-0084949, filed on Jun. 30, 2024, and 10-2023-0104652, filed on Aug. 10, 2023, in the Korean Intellectual Property Office, the disclosures of each of which are incorporated by reference herein in their entireties.

### BACKGROUND

### Field

The disclosure relates to an electronic device including an antenna and, for example, to an electronic device in which an exterior metal frame operates as an antenna radiator.

### Description of Related Art

The use of electronic devices such as bar-type, foldable-type, rollable-type, and sliding-type smartphones or tablet PCs is increasing, and various functions are being provided by the electronic devices. An electronic device may perform wireless communication with another electronic device using at least one antenna. For example, the electronic device may have at least a portion of a housing formed of a conductive member (e.g., metal), and at least a portion of the housing formed of the conductive member may be used as an antenna (or a radiator, or an antenna radiator) for performing wireless communication. The electronic device may adjust an operating frequency band using a tuner or a switch.

### SUMMARY

An example embodiment of the disclosure provides an electronic device including: a front surface plate facing a front side of the electronic device, a rear surface plate facing a rear side of the electronic device, a side surface member comprising a conductive material disposed between the front surface plate and the rear surface plate, the side surface member including a first conductive portion, a second conductive portion, and a non-conductive portion disposed between the first conductive portion and the second conductive portion, a wireless communication circuit electrically connected to the first conductive portion and configured to provide an RF signal of a specified frequency, and a first tuning unit electrically connected to the first conductive portion and the second conductive portion, wherein the first tuning unit includes: a variable capacitor electrically connected to the first conductive portion and the second conductive portion, and a plurality of switches configured to switch an electrical connection between opposite ends of the variable capacitor and at least one lumped element, wherein, as a capacitance of the variable capacitor is adjusted, a length of a radiator including the first conductive portion and the second conductive portion and configured to radiate the RF signal is adjusted.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a block diagram of an example electronic device in a network environment according to various embodiments.

FIG. 2A is a front perspective view of an example electronic device according to various embodiments.

FIG. 2B is a rear perspective view of the electronic device of FIG. 2A, according to various embodiments.

FIG. 3 is a diagram illustrating various regions around a side surface member that operates as an antenna radiator of an electronic device according to various embodiments.

FIG. 4 is a diagram illustrating an example of a tuning unit according to various embodiments.

FIG. 5 is a graph illustrating antenna characteristics of a radiator according to various embodiments.

FIG. 6 is a diagram illustrating an example of a tuning unit connected to electronic elements according to various embodiments.

FIG. 7 is a diagram illustrating an example of a tuning unit connected to electronic elements for ESD protection according to various embodiments.

FIG. 8 is a diagram illustrating an example of a tuning unit including a plurality of capacitors according to various embodiments.

FIG. 9 is a diagram illustrating various regions around a side surface member operating as an antenna radiator of an electronic device according to various embodiments.

FIG. 10 is a graph illustrating radiation efficiency of a radiator according to various embodiments.

FIG. 11 is a diagram illustrating various regions around a side surface member operating as an antenna radiator of an electronic device according to various embodiments.

FIG. 12A is a diagram illustrating an example of an antenna structure including a plurality of tuning units according to various embodiments.

FIG. 12B is a diagram illustrating an example of an antenna structure including a plurality of tuning units according to various embodiments.

FIG. 12C is a diagram illustrating an example of an antenna structure including a plurality of tuning units according to various embodiments.

FIG. 12D is a diagram illustrating an example of an antenna structure including a plurality of tuning units according to various embodiments.

### DETAILED DESCRIPTION

Hereinafter, various example embodiments of the disclosure will be described in greater detail with reference to the accompanying drawings. However, the disclosure may be implemented in various different forms and is not limited to the example embodiments set forth herein. To clearly describe the disclosure, parts irrelevant to the description may be omitted from the drawings, and similar or like parts are provided with similar or like reference signs.

The terms as used herein are expressed using currently used general terms in consideration of the functions mentioned in the disclosure and may use various different terms according to intentions of technicians engaged in the art, customs, or emergence of new technologies, and the like. Therefore, the terms as used herein should not be interpreted only by the nominal names the terms, but should be interpreted based on the meanings of the terms and the contents throughout the disclosure.

Such terms as “a first” and “a second” may be used to describe various elements, but the elements should not be limited by the terms. Theses terms are used only for the purpose of distinguishing one element from any other element.

Throughout the disclosure, when a certain part is described as being “connected” to another part, this includes not only the case where they are “directly connected” but also the case where they are “electrically connected” with another component interposed therebetween. Furthermore, when a part is referred to as “including” an element, it does not exclude the presence of other elements and may further include other elements.

As used herein, such phrases as “in an embodiment” appearing in various places of the disclosure do not necessarily refer to the same embodiment.

An embodiment of the disclosure may be represented by functional block elements and various processing steps. Some or all of the functional blocks may be implemented by various numbers of hardware and/or software components that perform specific functions. For example, the functional blocks of the disclosure may be implemented by one or more microprocessors or by circuit elements for predetermined functions. In addition, for example, the functional blocks of the disclosure may be implemented by various programming or scripting languages. The functional blocks may be implemented as algorithms executed in one or more processors. In addition, the disclosure may employ the prior art for electronic environment configurations, signal processing, and/or data processing. Such terms as “mechanism”, “element”, “means”, and “component” may be widely used, and are not limited to mechanical and physical components.

Connection lines or connection members between the elements illustrated in the drawings merely represent an example of functional connections and/or physical or circuit connections. In an actual device, the connections between elements may be represented through various alternative or additional functional, physical, or circuit connections.

Hereinafter, the disclosure will be described in greater detail with reference to the accompanying drawings.

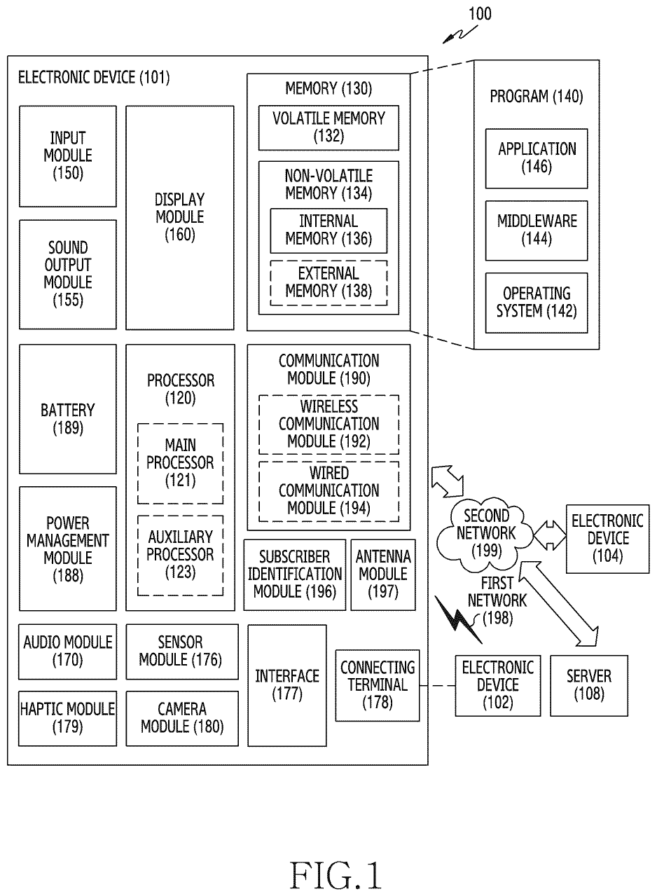

FIG. 1 is a block diagram illustrating an example electronic device 101 in a network environment 100 according to various embodiments. Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In various embodiments, at least one of the components (e.g., the connecting terminal 178) may be omitted from the electronic device 101, or one or more other components may be added in the electronic device 101. In various embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121. Thus, the processor 120 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of Ims or less) for implementing URLLC.

The antenna module 197 may transmit or receive a signal or power to or from the outside (e.g., the external electronic device) of the electronic device 101. According to an embodiment, the antenna module 197 may include an antenna including a radiating element including a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In an embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

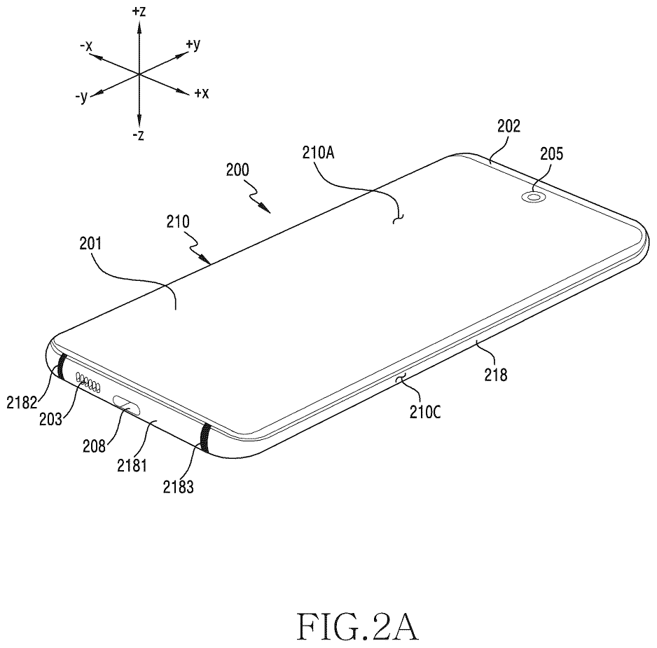

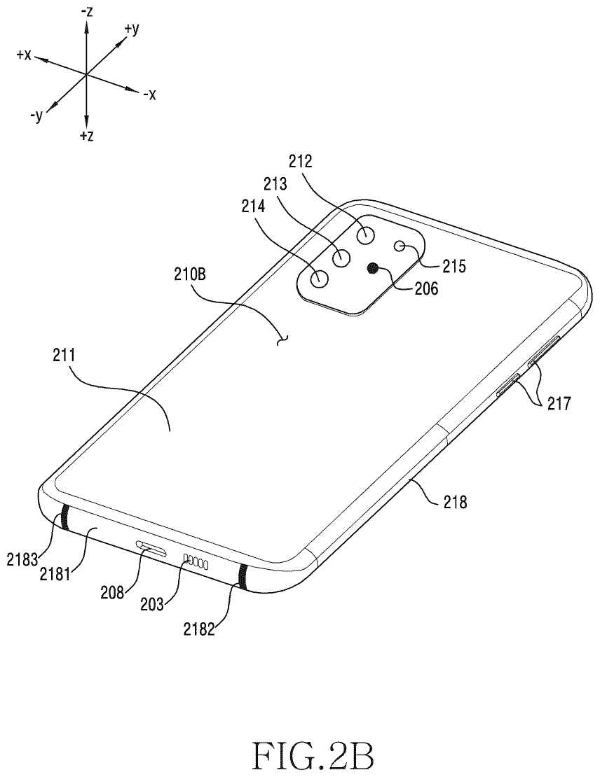

FIG. 2A is a font perspective view of an electronic device according to various embodiments, and FIG. 2B is a rear perspective view of the electronic device of FIG. 2A, according to various embodiments.

Referring to FIGS. 2A and 2B, the electronic device 200 (e.g., the electronic device 101 in FIG. 1) according to an embodiment may include a housing 210 including a first surface (or a “front surface) 210A, a second surface (or a “rear surface”) 210B, and a side surface (a “side wall”) 210C surrounding a space between the first surface 210A and the second surface 210B. In an embodiment (not illustrated), the term “housing 210” may refer to a structure defining a part of the first surface 210A, the second surface 210B, and the side surface 210C of FIGS. 2A and 2B.

According to an embodiment, at least a portion of the first surface 210A may be formed by a substantially transparent front surface plate 202 (or a “cover window) (e.g., a glass plate or a polymer plate including various coating layers). According to an embodiment, the front plate 202 may include a curved portion bent and seamlessly extending from the first surface 210A toward the rear plate 211 in at least one side edge portion.

According to an embodiment, the second surface 210B may be formed by a substantially opaque rear surface plate 211. The rear surface plate 211 may be made of, for example, coated or colored glass, ceramic, polymer, metal (e.g., aluminum, stainless steel (STS), or magnesium), or a combination of two or more of these materials. According to an embodiment, the rear surface plate 211 may include a curved portion bent and extending seamlessly from the second surface 210B toward the front surface plate 202 in at least one side edge portion.

According to an embodiment, the side surface 210C may be coupled to the front surface plate 202 and the rear surface plate 211, and may be formed by a side surface member (or a “bracket”) 218 including metal and/or polymer. In various embodiments, the rear surface plate 211 and the side surface member 218 may be integrally formed and may include the same material (e.g., a metal material such as aluminum). In an example, the side surface member 218 may include a conductive portion 2181 and/or one or more non-conductive portions 2182 and 2183. For example, the first non-conductive portion 2182 may be disposed at one end (e.g., an end in the −x direction) of the conductive portion 2181, and a second non-conductive portion 2183 may be disposed at another end (e.g., an end in the +x direction) of the conductive portion 2181, so as to electrically isolate the conductive portion 2181. In another example, the conductive portion 2181 may be fed with power from a wireless communication circuit (e.g., the wireless communication module 192 of FIG. 1), and may operate as an antenna radiator for transmitting and/or receiving an RF signal in a predetermined frequency band.

According to an embodiment, the electronic device 200 may include at least one of a display 201, an audio module 203, a sensor module (not illustrated), camera modules 205, 212, 213, 214, 215, and 206, a key input device 217, or a connector hole 208. In various embodiments, the electronic device 200 may omit at least one of the components (e.g., the key input device 217) or may additionally include another component.

In various embodiments, the electronic device 200 may further include a light-emitting element, and the light-emitting element may be disposed at a position adjacent to the display 201 in the region provided by the front surface plate 202. The light-emitting element may, for example, provide state information of the electronic device 200 in the form of light. In an embodiment, the light-emitting element may provide, for example, a light source that operates in conjunction with the operation of the camera module 205. The light-emitting element may include, for example, an LED, an IR LED, and/or a xenon lamp.

According to an embodiment, the display 201 may be visible to the outside of the electronic device 200 through a substantial portion of the front plate 202. In various embodiments, the edges of the display 201 may be substantially the same as the shape of the outer periphery (e.g., a curved surface) of the front plate 202 adjacent thereto. In an embodiment (not illustrated), the distance between the periphery of the display 201 and the periphery of the front surface plate 202 may be substantially constant in order to enlarge the visible area of the display 201. In an embodiment (not illustrated), the electronic device 200 may include another electronic component, such as the camera module 205, a proximity sensor (not illustrated), or an illuminance sensor (not illustrated) aligned with a recess or an opening provided in a portion of the screen display area of the display 201.

In an embodiment (not illustrated), at least one of a camera module 212, 213, 214, or 215, a fingerprint sensor (not illustrated), and a flash 206 may be disposed on a rear side of a display area of the display 201. In an embodiment (not illustrated), the display 201 may be coupled to or disposed adjacent to a touch-sensitive circuit, a pressure sensor capable of measuring a touch intensity (pressure), and/or a digitizer configured to detect an electromagnetic field-type stylus pen.

According to an embodiment, the audio module 203 may include a microphone hole and/or a speaker hole. The microphone hole may include a microphone disposed therein so as to acquire external sound. In various embodiments, multiple microphones may be disposed so as to detect the direction of sound. In various embodiments, the speaker hole and the microphone hole may be implemented as a single hole, or a speaker (e.g., a piezo speaker) may be included without a speaker hole. The speaker hole may include an external speaker hole and/or a receiver hole for a receiver call.

According to an embodiment, by including a sensor module (not illustrated), the electronic device 200 may generate an electrical signal or a data value corresponding to an internal operating state or an external environmental condition. For example, the sensor module may further include, for example, a proximity sensor disposed on the first surface 210a of the housing 210, a fingerprint sensor incorporated in or disposed adjacent to the display 201, and/or a biometric sensor (e.g., an HRM sensor) disposed on the second surface 210B of the housing 210. The electronic device 200 may further include at least one of sensor modules (not illustrated), such as a gesture sensor, a gyro sensor, an atmospheric pressure sensor, a magnetic sensor, an acceleration sensor, a grip sensor, a color sensor, an infrared (IR) sensor, a biometric sensor, a temperature sensor, a humidity sensor, or an illuminance sensor.

According to an embodiment, the camera modules 205, 212, 213, 214, and 206 may include a first camera device 205 disposed on the first surface 210A of the electronic device 200, second camera devices 212, 213, 214, and 215 disposed on the second surface 210B thereof, and/or a flash 206. In an example, each of the camera modules 205, 212, 213, 214, and 215 may include one or more lenses, an image sensor, and/or an image signal processor. In another example, the flash 206 may include a light-emitting diode or a xenon lamp. In various embodiments, two or more lenses (e.g., an infrared camera lens, a wide-angle lens, and a telephoto lens) and image sensors may be disposed on one side of the electronic device 200.

According to an embodiment, the key input devices 217 may be disposed on the side surface 210C of the housing 210. In an embodiment, the electronic device 200 may not include some or all of the above-described key input devices 217, and a key input device 217 not included may be implemented in another form, such as a soft key, on the display 201. In various embodiments, the key input devices may include a fingerprint sensor disposed on the second surface 210B of the housing 210.

According to an embodiment, the connector hole 208 may accommodate a connector configured to transmit and receive power and/or data to and from an external electronic device, and/or a connector configured to transmit and receive an audio signal to and from an external electronic device. For example, the connector hole 208 may include a USB connector or an earphone jack. In an embodiment, the USB connector and the earphone jack may be implemented as a single hole (e.g., 208 in FIGS. 2A and 2B), and according to an embodiment (not illustrated), the electronic device 200 may transmit/receive power and/or data or transmit/or receive an audio signal to/from an external electronic device (e.g., the electronic devices 102 and 104 in FIG. 1) without a separate connector hole.

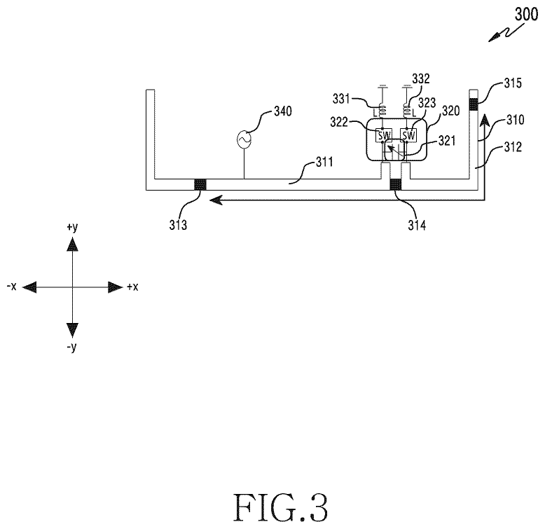

FIG. 3 is a diagram illustrating various regions around a side surface member that operates as an antenna radiator of an electronic device according to various embodiments.

Referring to FIG. 3, an electronic device 300 according to an embodiment (e.g., the electronic device 200 of FIGS. 2A and 2B) may include a side surface member 310 including at least one conductive portion 311 or 312 and at least one non-conductive portion 313, 314, or 315 (e.g., the side surface member 218 of FIG. 2A), a tuning unit 320, lumped elements 331 and 332, and a wireless communication circuit 340. At least one of the components of the electronic device 300 according to an embodiment may be the same as or similar to at least one of the components of the electronic device 101 of FIG. 1 or the electronic device 200 of FIGS. 2A and 2B, and redundant descriptions thereof will be omitted below.

According to an embodiment, the side surface member 310 may form at least a portion of a side surface (e.g., the side surface 210C of FIG. 2A) of the electronic device 300. The side surface member 310 may include one or more conductive portions 311 and 312 and one or more non-conductive portions 313, 314, and 415. The one or more non-conductive portions 313, 314, and 415 may electrically isolate the one or more conductive portions 311 and 312 from each other, and may be referred to as segmentation portions.

According to an embodiment, the side surface member 310 may include a first conductive portion 311, a second conductive portion 312, a first non-conductive portion 313, a second non-conductive portion 314, and/or a third non-conductive portion 315. Lengths and arrangement positions of the first conductive portion 311, the second conductive portion 312, the first non-conductive portion 313, the second non-conductive portion 314, and the third non-conductive portion 315 may be variously configured. For example, the first non-conductive portion 313 may be disposed at one end (e.g., the end in the −x direction) of the first conductive portion 311, and the second non-conductive portion 314 may be disposed at another end (e.g., the end in the +x direction) of the first conductive portion 311. For example, the first non-conductive portion 313 and/or the second non-conductive portion 314 may electrically isolate the first conductive portion 311. For example, the second non-conductive portion 314 may be disposed at one end (e.g., the end in the −x direction) of the second conductive portion 312, and the third non-conductive portion 315 may be disposed at another end (e.g., the end in the +y direction) of the second conductive portion 312. For example, the second non-conductive portion 314 and/or the third non-conductive portion 315 may electrically isolate the second conductive portion 312. For example, a portion of the side surface member 310 that contacts the first non-conductive portion 313 and is located on the −x-axis direction side of the first non-conductive portion 313, or a portion of the side surface member 310 that contacts the third non-conductive portion 315 and is located on the +y-axis direction side of the third non-conductive portion 315, may include a conductive portion.

According to an embodiment, the tuning unit 320 may include a variable capacitor 321 and at least one switch 322 and 323. The variable capacitor 321 is a capacitor element whose capacitance is adjustable, and the variable capacitor 321 may form an electrical path between the first conductive portion 311 and the second conductive portion 312. The variable capacitor 321 may be connected to the first conductive portion 311 and the second conductive portion 312. For example, one end of the variable capacitor 321 may be connected to the first conductive portion 311, and the other end of the variable capacitor may be connected to the second conductive portion 312.

According to an embodiment, the one end and the other end of the variable capacitor 321 may be connected to at least one switch 322 and 323. For example, one end of the variable capacitor 321 may be connected to the switch 322, and the other end of the variable capacitor 321 may be connected to the switch 323.

According to an embodiment, the at least one switch 322 and 323 may be connected to one or more lumped elements 331 and 332. The lumped elements 331 and 332 may include, for example, an inductor and/or a capacitor, but are not limited thereto.

According to an embodiment, the switch 322 connected to one end of the variable capacitor 321 may be connected to ground via the lumped element 331. The switch 323 connected to the other end of the variable capacitor 321 may be connected to ground via the lumped element 332.

According to an embodiment, the tuning unit 320 may adjust an electrical length of a radiator including the first conductive portion 311 and the second conductive portion 312 by adjusting an electrical capacitance of the variable capacitor 321 and adjusting switching paths of the one or more switches 322 and 323 under the control of the electronic device 300. For example, the tuning unit 320 may short-circuit at least one of the switch 322 and the switch 323 and adjust the electrical capacitance of the variable capacitor 321 under the control of the electronic device 300. Based on a combination of the one or more lumped elements 331 and 332 and adjustment of the electrical capacitance of the variable capacitor 321, the electrical length and the operating frequency band of the radiator including the first conductive portion 311 and the second conductive portion 312 may be adjusted.

According to an embodiment, the tuning unit 320 may adjust an operating frequency band of a radiator including the first conductive portion 311 and the second conductive portion 312 based on a frequency band of an RF signal provided from a wireless communication circuit 340 to be described later.

According to an embodiment, the wireless communication circuit 340 may provide an RF signal to the first conductive portion 311. The wireless communication circuit 340 may be configured to transmit or receive an RF signal in one or more designated frequency bands through a radiator including the first conductive portion 311 and the second conductive portion 312.

According to an embodiment, the wireless communication circuit 340 may be included in, for example, a portion of the wireless communication module 190 of FIG. 1. The wireless communication circuit 340 may be disposed on one or more printed circuit boards disposed in an inner space of the electronic device 300. For example, the wireless communication circuit 340 may be disposed on a portion of the printed circuit board adjacent to the first conductive portion 311, but is not limited thereto.

In the above description, the wireless communication circuit 340 has been described as providing an RF signal to the first conductive portion 311 through an electrical path connected thereto; however, the disclosure is not limited thereto. For example, an RF signal from the wireless communication circuit 340 may be provided to a conductive portion other than the first conductive portion 311.

In addition, for example, according to design changes, the electronic device 300 may include antennas operating in various frequency bands through a greater number of conductive portions that are electrically isolated from each other by a greater number of non-conductive portions. In addition, the electronic device 300 may include a greater number of tuning units that connect the conductive portions, and operating frequencies of the antennas may be variously adjusted due to adjustment of lengths of radiators through the tuning units.

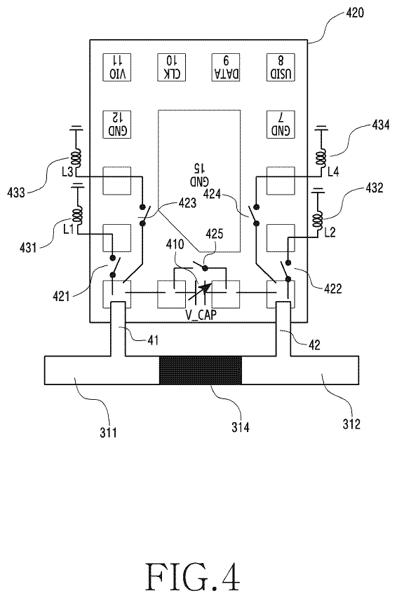

FIG. 4 is a diagram illustrating an example of a tuning unit according to various embodiments.

The tuning unit 420 of FIG. 4 may correspond to the tuning unit 320 of FIG. 3.

Referring to FIG. 4, in an embodiment, the tuning unit 420 may be implemented as an integrated circuit (IC) chip including a variable capacitor 410, a first switch 421, a second switch 422, a third switch 423, a fourth switch 424, and/or a fifth switch 425.

According to an embodiment, the variable capacitor 410 may be disposed between the first conductive portion 311 and the second conductive portion 312, and opposite ends of the variable capacitor 410 may be electrically connected to the first conductive portion 311 and the second conductive portion 312, respectively. For example, one end of the variable capacitor 410 may be electrically connected to a first protrusion 41 protruding from the first conductive portion 311, and the other end of the variable capacitor 410 may be electrically connected to a second protrusion 42 protruding from the second conductive portion 312.

According to an embodiment, one end of the variable capacitor 410 may be connected to the first switch 421, and the first switch 421 may be connected to ground via a first lumped element 431. For example, the other end of the variable capacitor 410 may be connected to the second switch 422, and the second switch 422 may be connected to ground via a second lumped element 432.

According to an embodiment, one end of the variable capacitor 410 may be connected to the third switch 423, and the third switch 423 may be connected to ground via a third lumped element 433. For example, the other end of the variable capacitor 410 may be connected to the fourth switch 424, and the fourth switch 424 may be connected to ground via a fourth lumped element 434.

According to an embodiment, at least some of the lumped elements 431, 432, 433, and 434 connected to switches in the tuning unit 420 may have different element values. For example, the first lumped element 431 connected to the first switch 421 may be an inductor having an inductance value of L1, the second lumped element 432 connected to the second switch 422 may be an inductor having an inductance value of L2, the third lumped element 433 connected to the third switch 423 may be an inductor having an inductance value of L3, and the fourth lumped element 434 connected to the fourth switch 424 may be an inductor having an inductance value of L4. For example, at least some of the inductance values L1, L2, L3, and L4 may differ from the other inductance values.

In the above description, the lumped elements 431, 432, 433, and 434 have been described as inductors; however, the disclosure is not limited thereto. According to an embodiment, the lumped elements 431, 432, 433, and 434 may include an inductor and/or a capacitor.

According to an embodiment, the fifth switch 425 may be connected in parallel to opposite ends of the variable capacitor 410.

According to an embodiment, by adjusting the capacitance of the variable capacitor 410 and short-circuiting at least one of the first switch 421, the second switch 422, the third switch 423, the fourth switch 424, or the fifth switch 425, an electrical length of a radiator including the first conductive portion 311 and the second conductive portion 312 may be adjusted.

According to an embodiment, as an RF signal is applied from the wireless communication circuit 340 to the first conductive portion 311, the capacitance of the variable capacitor 410 is adjusted, and at least one of the first switch 421, the second switch 422, the third switch 423, the fourth switch 424, or the fifth switch 425 is short-circuited, the electrical length of the radiator including the first conductive portion 311 and the second conductive portion 312 may be adjusted. In addition, an RF signal in an operating frequency band corresponding to the adjusted electrical length of the radiator may be radiated through the radiator.

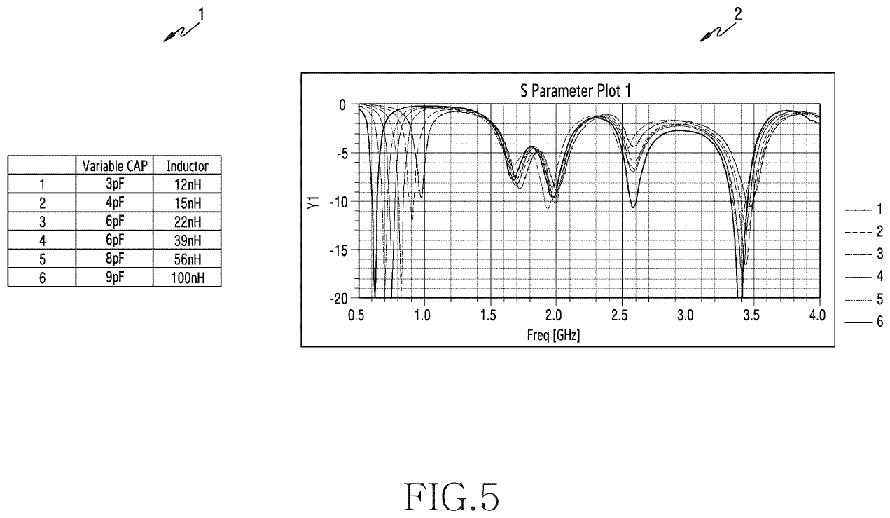

FIG. 5 is a graph illustrating antenna characteristics of a radiator according to various embodiments.

The graph of FIG. 5 shows return loss of a radiator having an adjusted length by adjusting a capacitance of the variable capacitor 410 of FIG. 4 and short-circuiting at the first switch 421, the second switch 422, the third switch 423, the fourth switch 424, or the fifth switch 425.

Referring to identification number 1 of FIG. 5, in a low-band (LB) frequency band of 600 MHz to 1,000 MHz, by adjusting the capacitance of the variable capacitor 410 of FIG. 4 and short-circuiting at the first switch 421, the second switch 422, the third switch 423, the fourth switch 424, or the fifth switch 425, the capacitance of the variable capacitor 410 may be variously configured (e.g., 3 pF, 4 pF, 6 pF, 7 pF, 8 pF, 9 pF), and combinations of element values of the lumped elements 431, 432, 433, and 434 may be variously configured (e.g., 12 nH, 15 nH, 22 nH, 39 nH, 56 nH, 100 nH).

Referring to identification number 2 of FIG. 5, it can be confirmed that RF signals are radiated satisfactorily through a radiator having an adjusted length in the LB frequency band of 600 MHz to 1,000 MHz. With respect to radiation of RF signals in an MB/HB band of 1,700 MHz to 2,700 MHz through a radiator having an adjusted electrical length, since there is little change in antenna performance, it can be confirmed that there is little degradation in antenna performance in a situation where RF signals are radiated using carrier aggregation (CA) and/or E-UTRA NR Dual Connectivity (ENDC) technology.

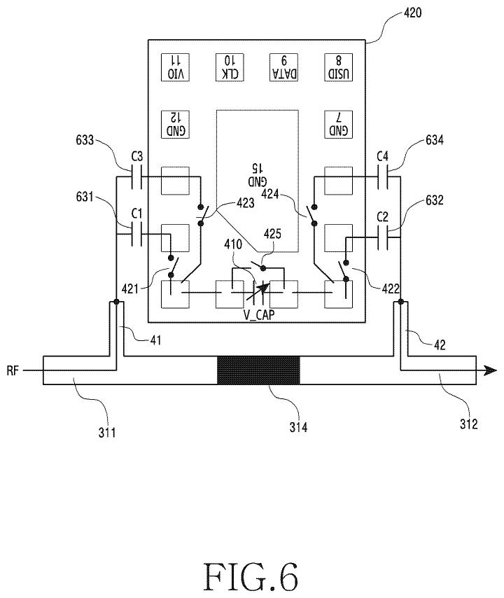

FIG. 6 is a diagram illustrating an example of a tuning unit connected to electronic elements according to various embodiments.

The tuning unit 420 of FIG. 6 may correspond to the tuning unit 320 of FIG. 3.

Referring to FIG. 6, in an embodiment, the tuning unit 420 may be implemented as an integrated circuit (IC) chip including a variable capacitor 410, a first switch 421, a second switch 422, a third switch 423, a fourth switch 424, and/or a fifth switch 425.

According to an embodiment, the tuning unit 420 may be disposed between the first conductive portion 311 and the second conductive portion 312, and may be electrically connected to the first conductive portion 311 and the second conductive portion 312. For example, the tuning unit 420 may be electrically connected to the first conductive portion 311 and the second conductive portion 312 through at least one of a first capacitor 631, a second capacitor 632, a third capacitor 633, or a fourth capacitor 634. For example, the tuning unit 420 may be electrically connected to the first conductive portion 311 through at least one of the first capacitor 631 or the third capacitor 633, and may be electrically connected to the second conductive portion 312 through at least one of the second capacitor 632 or the fourth capacitor 634.

According to an embodiment, the variable capacitor 410 may be disposed between the first conductive portion 311 and the second conductive portion 312, and opposite ends of the variable capacitor 410 may be electrically connected to the first conductive portion 311 and the second conductive portion 312 via the first switch 421 and the second switch 422, respectively. For example, one end of the variable capacitor 410 may be electrically connected, via the first switch 421 and the first capacitor 631, to a first protrusion 41 protruding from the first conductive portion 311. For example, the other end of the variable capacitor 410 may be electrically connected, via the second switch 422 and the second capacitor 632, to a second protrusion 42 protruding from the second conductive portion 312.

According to an embodiment, a third switch 433 and a third capacitor 633 may be additionally connected between one end of the variable capacitor 410 and the first protrusion 41. The third switch 433 and the third capacitor 633 may be connected in parallel with the first switch 421 and the first capacitor 631.

According to an embodiment, a fourth switch 434 and a fourth capacitor 634 may be additionally connected between the other end of the variable capacitor 410 and the second protrusion 42. The fourth switch 434 and the fourth capacitor 634 may be connected in parallel with the second switch 422 and the second capacitor 632.

According to an embodiment, at least some of capacitors 631, 632, 633, and 634 connected to switches in the tuning unit 420 may have different element values. For example, the first capacitor 631 connected to the first switch 421 may have a capacitance value C1, the second capacitor 632 connected to the second switch 422 may have a capacitance value C2, the third capacitor 633 connected to the third switch 423 may have a capacitance value C3, and the fourth capacitor 634 connected to the fourth switch 424 may have a capacitance value C4. For example, at least some of the capacitance values C1, C2, C3, or C4 may differ from the other capacitance values.

According to an embodiment, the fifth switch 425 may be connected in parallel to opposite ends of the variable capacitor 410.

According to an embodiment, by adjusting the capacitance of the variable capacitor 410 and short-circuiting at least one of the first switch 421, the second switch 422, the third switch 423, the fourth switch 424, or the fifth switch 425, an electrical length of a radiator including the first conductive portion 311 and the second conductive portion 312 may be adjusted.

According to an embodiment, as an RF signal is applied from the wireless communication circuit 340 to the first conductive portion 311, the capacitance of the variable capacitor 410 is adjusted, and at least one of the first switch 421, the second switch 422, the third switch 423, the fourth switch 424, or the fifth switch 425 is short-circuited, the electrical length of the radiator including the first conductive portion 311 and the second conductive portion 312 may be adjusted. In addition, an RF signal in an operating frequency band corresponding to the adjusted electrical length of the radiator may be radiated through the radiator.

For example, a capacitance range of the variable capacitor 410 in the tuning unit 420 may be from 0.75 pF to 9 pF, and the capacitance may be adjusted by dividing the range into 30 states. In this case, it may be difficult to secure optimized antenna performance depending on an LB frequency band. Accordingly, for example, when all C1, C2, C3, and C4 of FIG. 6 are configured to differ from each other, 16 capacitance values may be provided according to combinations of C1, C2, C3, and C4. In this case, the variable capacitor 410 may be adjustable to 30 capacitance values, and by short-circuiting at least one of the first switch 421, the second switch 422, the third switch 423, the fourth switch 424, or the fifth switch 425, an electrical length of a radiator may be adjusted in 480 states (=30×16). Accordingly, the range of capacitance values configurable for adjustment of an operating frequency and adjustment of a radiator length may be diversified.

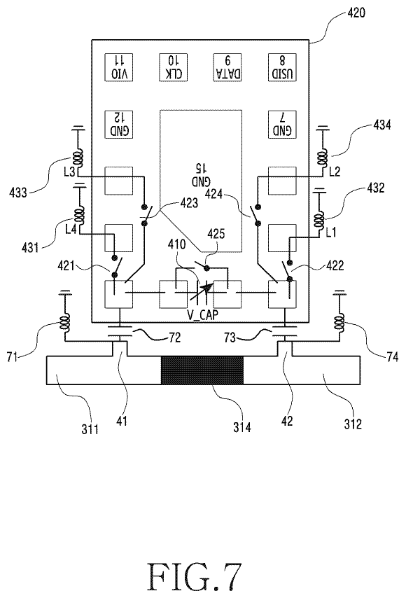

FIG. 7 is a diagram illustrating an example of a tuning unit connected to electronic elements for ESD protection according to various embodiments.

The tuning unit 420 of FIG. 7 may correspond to the tuning unit 320 of FIG. 3.

According to an embodiment, opposite ends of the variable capacitor 410 may be electrically connected to the first conductive portion 311 and the second conductive portion 312 via electronic elements for electrostatic discharge (ESD) protection. For example, the electronic elements for ESD protection may include inductors and capacitors, but are not limited thereto.

For example, one end of the variable capacitor 410 may be connected to the first protrusion 41 of the first conductive portion 311 through a capacitor 72. The capacitor 72 may be connected in series between one end of the variable capacitor 410 and the first protrusion 41 of the first conductive portion 311. For example, the first protrusion 41 of the first conductive portion 311 may be connected to an inductor 71, and the inductor 71 may be connected to ground. The capacitor 72 and the inductor 71 may protect the tuning unit 420 by mitigating an electrical surge generated in the first conductive portion 311.

For example, the other end of the variable capacitor 410 may be connected to the second protrusion 42 of the second conductive portion 312 through a capacitor 73. The capacitor 73 may be connected in series between the other end of the variable capacitor 410 and the second protrusion 42 of the second conductive portion 312. For example, the second protrusion 42 of the second conductive portion 312 may be connected to an inductor 74, and the inductor 74 may be connected to ground. The capacitor 73 and the inductor 74 may protect the tuning unit 420 by mitigating an electrical surge generated in the second conductive portion 312.

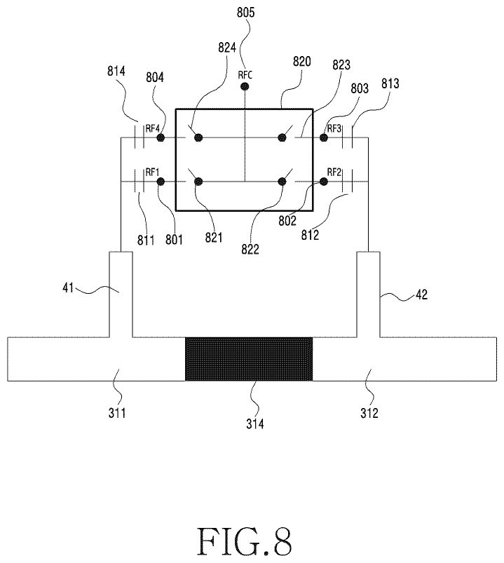

FIG. 8 is a diagram illustrating an example of a tuning unit including a plurality of capacitors according to various embodiments.

The tuning unit 820 of FIG. 8 may correspond to the tuning unit 320 of FIG. 3.

Referring to FIG. 8, in an embodiment, the tuning unit 820 may include an single pole multi throw (SPMT) switch. For example, the tuning unit 820 may include an single pole 4 throw (SP4T) switch. In this case, an RF1 port 801 of the SP4T switch may be connected to the protrusion 41 of the first conductive portion 311 through a first capacitor 811, and an RF4 port 804 may be connected to the protrusion 41 of the first conductive portion 311 through a fourth capacitor 814. For example, an RF2 port 802 may be connected to the protrusion 42 of the second conductive portion 312 through a second capacitor 812, and an RF3 port 803 may be connected to the protrusion 42 of the second conductive portion 312 through a third capacitor 813.

According to an embodiment, by short-circuiting at least one of a first switch 821, a second switch 822, a third switch 823, or a fourth switch 824 in the SP4T switch, an electrical length of a radiator including the first conductive portion 311 and the second conductive portion 312 may be adjusted based on a combination of one or more of the first capacitor 811, the second capacitor 812, the third capacitor 813, or the fourth capacitor 814. In addition, for example, an RFC port 805 may be a common port connected to the first switch 821, the second switch 822, the third switch 823, or the fourth switch 824.

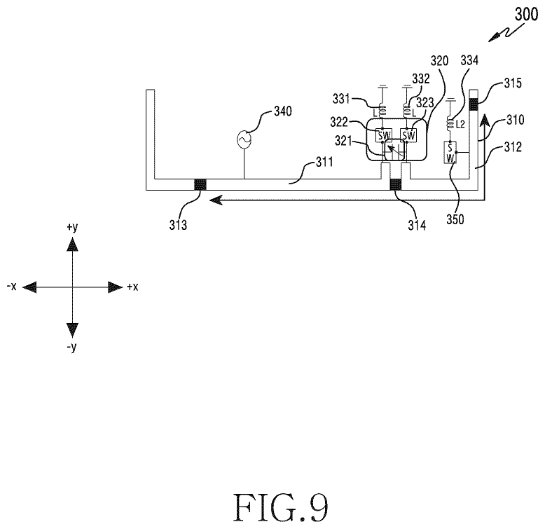

FIG. 9 is a diagram illustrating various regions around a side surface member operating as an antenna radiator of an electronic device according to various embodiments.

Referring to FIG. 9, compared with FIG. 3, a third lumped element 334 may be additionally connected to the second conductive portion 312 of FIG. 9 through a switch 350. According to an embodiment, the tuning unit 320 may, under the control of the electronic device 300, short-circuit at least one of the switch 322, the switch 323, or the switch 350 and adjust an electrical capacitance of the variable capacitor 321. Based on a combination of the lumped elements 331, 332, and 334 and adjustment of the electrical capacitance of the variable capacitor 321, an electrical length of a radiator including the first conductive portion 311 and the second conductive portion 312 may be adjusted.

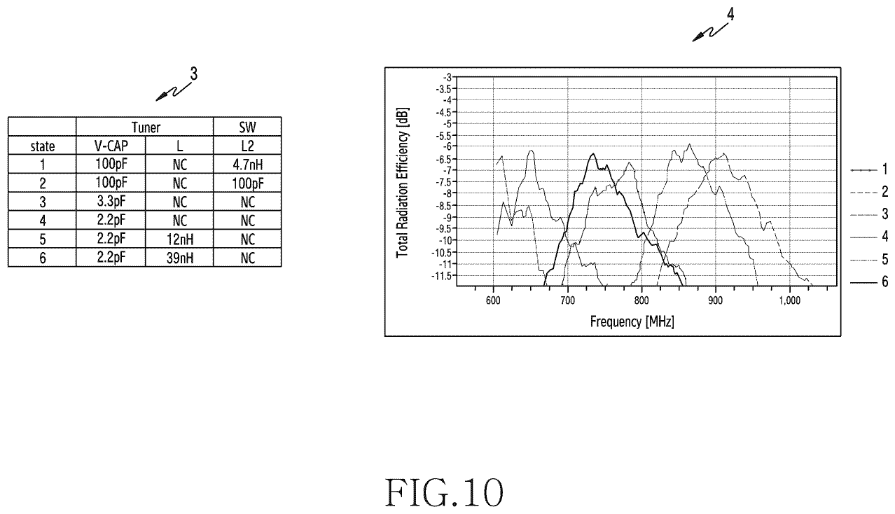

FIG. 10 is a graph illustrating radiation efficiency of a radiator according to various embodiments.

FIG. 10 illustrates radiation efficiency of a radiator having an adjusted electrical length by adjusting the capacitance of the variable capacitor 321 of FIG. 9 and short-circuiting at least one of the switch 322, the switch 323, or the switch 350.

Referring to identification number 3 of FIG. 10, in a low band (LB) frequency band of 600 MHz to 1,000 MHz, by adjusting the capacitance of the variable capacitor 321 of FIG. 9 and short-circuiting at least one of the switch 322, the switch 323, or the switch 350, the capacitance of the variable capacitor 321 may be variously configured (e.g., 100 pF, 3.3 pF, 2.2 pF), and element values of combinations of the lumped elements 331, 332, and 334 may be variously configured (e.g., 4.7 nH, 100 pF).

In addition, referring to identification number 4 of FIG. 10, it can be confirmed that RF signals are radiated satisfactorily at various frequencies within the LB frequency band of 600 MHz to 1,000 MHz. Accordingly, frequency switching may be possible so as to achieve favorable radiation efficiency within the LB frequency band of 600 MHz to 1,000 MHz.

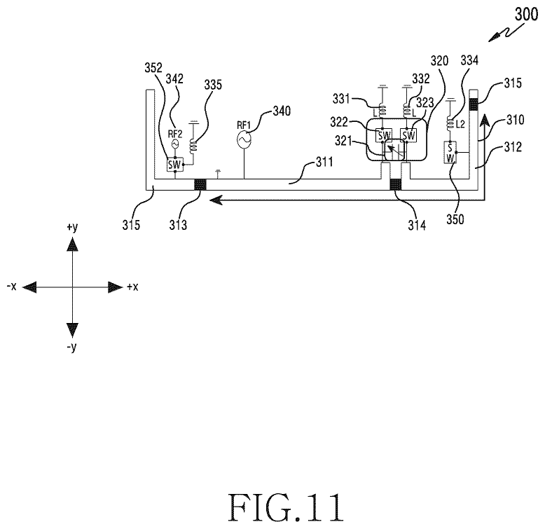

FIG. 11 is a diagram illustrating various regions around a side surface member operating as an antenna radiator of an electronic device according to various embodiments.

Referring to FIG. 11, compared with FIG. 9, a fourth lumped element 335 and a wireless communication circuit 342 may be additionally connected to a third conductive portion 315 of FIG. 11 through a switch 352.

Accordingly, a first RF signal may be radiated through a radiator which includes the first conductive portion 311 and the second conductive portion 312, an electrical length of which is adjusted by the tuning unit 320. In addition, a second RF signal may be radiated through the third conductive portion 315.

For example, an LB signal, an MB signal, an HB signal, or a UHB signal may be radiated through the radiator including the first conductive portion 311 and the second conductive portion 312, the electrical length of which is adjusted by the tuning unit 320. In addition, for example, independently of this, an MB signal, an HB signal, or a UHB signal may be radiated through the third conductive portion 315.

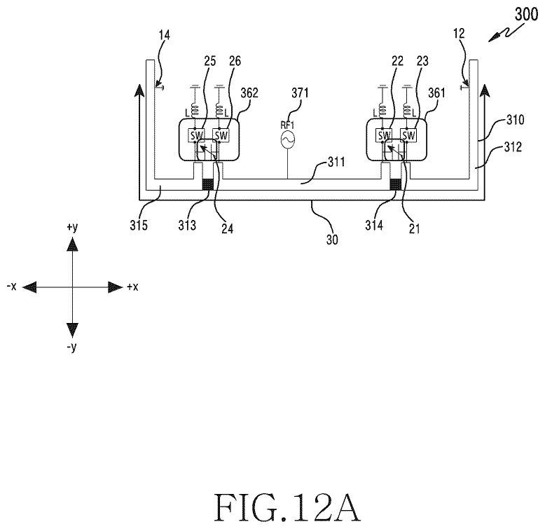

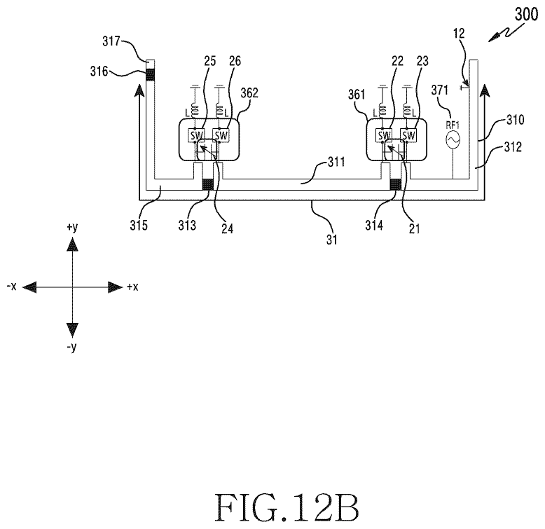

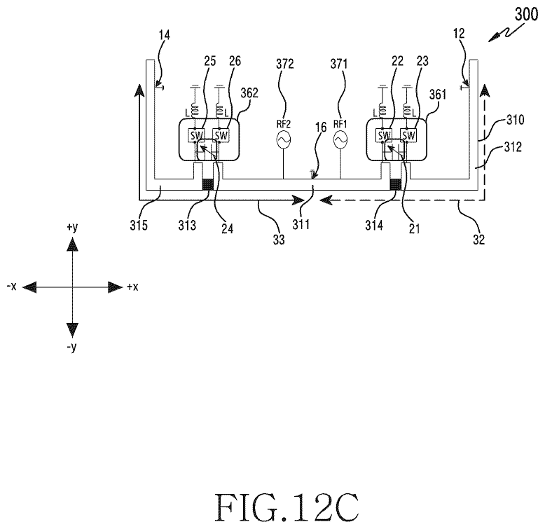

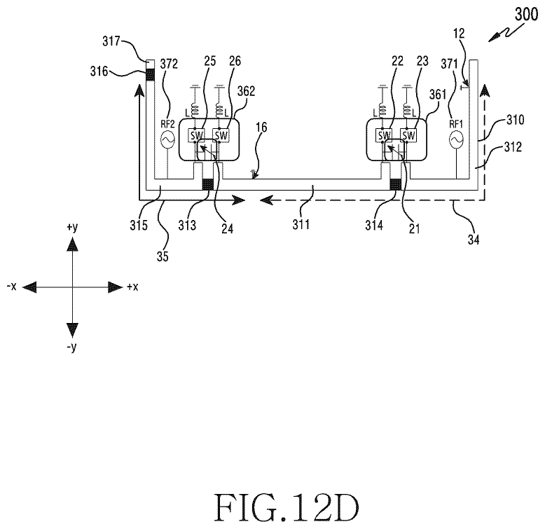

FIG. 12A is a diagram illustrating an example of an antenna structure including a plurality of tuning units according to various embodiments.

Referring to FIG. 12A, in some regions around a side surface member 310 operating as an antenna radiator of the electronic device 300 according to an embodiment, a first tuning unit 361 and a second tuning unit 362 may be disposed. According to an embodiment, a first wireless communication circuit 371 may be electrically connected to the side surface member 310 operating as an antenna radiator of the electronic device 300.

For example, the first tuning unit 361 may be disposed around a second non-conductive portion 314 and may be electrically connected to a first conductive portion 311 and a second conductive portion 312. For example, the second tuning unit 362 may be disposed around a first non-conductive portion 313 and may be electrically connected to the first conductive portion 311 and a third conductive portion 315. For example, the first wireless communication circuit 371 may be connected to the first conductive portion 311 to provide an RF signal to the first conductive portion 311.

According to an embodiment, a ground point 12 may be formed on the second conductive portion 312, and the second conductive portion 312 may be connected to ground through the ground point 12. For example, a ground point 14 may be formed on the third conductive portion 315, and the third conductive portion 315 may be connected to ground through the ground point 14. In addition, for example, the ground point 12 and the ground point 14 may be connected to a printed circuit board within the electronic device 300 and/or another component operating as ground.

According to an embodiment, a portion 30 of the side surface member 310 between the ground point 12 and the ground point 14 may operate as an antenna radiator. According to an embodiment, by controlling a variable capacitor 21 and switches 22 and 23 in the first tuning unit 361 and controlling a variable capacitor 24 and switches 25 and 26 in the second tuning unit 362, an electrical length of a radiator including the first conductive portion 311, a portion of the second conductive portion 312 (e.g., a portion between the second non-conductive portion 314 and the ground point 12), and a portion of the third conductive portion 315 (e.g., a portion between the first non-conductive portion 313 and the ground point 14) may be adjusted. According to an embodiment, by controlling the variable capacitor 21 and the switches 22 and 23 in the first tuning unit 361 and controlling the variable capacitor 24 and the switches 25 and 26 in the second tuning unit 362, RF signals of various frequencies provided from the first wireless communication circuit 371 may be effectively radiated through the radiator having an adjusted length.

FIG. 12B is a diagram illustrating an example of an antenna structure including a plurality of tuning units according to various embodiments.

Referring to FIG. 12B, in some regions around a side surface member 310 operating as an antenna radiator of the electronic device 300 according to an embodiment, a first tuning unit 361 and a second tuning unit 362 may be disposed. According to an embodiment, a first wireless communication circuit 371 may be electrically connected to the side surface member 310 operating as an antenna radiator of the electronic device 300. In FIG. 12B, in an embodiment, the first wireless communication circuit 371 may be connected to a second conductive portion 312.

For example, the first tuning unit 361 may be disposed around a second non-conductive portion 314 and may be electrically connected to a first conductive portion 311 and a second conductive portion 312. For example, the second tuning unit 362 may be disposed around a first non-conductive portion 313 and may be electrically connected to the second conductive portion 312 and a third conductive portion 315.

For example, the first wireless communication circuit 371 may be connected to the second conductive portion 312 to provide an RF signal to the second conductive portion 312.

For example, a ground point 12 may be formed on the second conductive portion 312, and the second conductive portion 312 may be connected to ground through the ground point 12. For example, the ground point 12 may be connected to a printed circuit board within the electronic device 300 and/or another component operating as ground. For example, the third conductive portion 315 may be electrically isolated from a fourth conductive portion 317 by a third non-conductive portion 316.

According to an embodiment, a portion 31 of the side surface member 310 between the ground point 12 and the third non-conductive portion 316 may operate as an antenna radiator. According to an embodiment, by controlling a variable capacitor 21 and switches 22 and 23 in the first tuning unit 361 and controlling a variable capacitor 24 and switches 25 and 26 in the second tuning unit 362, an electrical length of a radiator including the first conductive portion 311, a portion of the second conductive portion 312 (e.g., a portion between the second non-conductive portion 314 and the ground point 12), and the third conductive portion 315 may be adjusted. According to an embodiment, by controlling the variable capacitor 21 and the switches 22 and 23 in the first tuning unit 361 and controlling the variable capacitor 24 and the switches 25 and 26 in the second tuning unit 362, RF signals of various frequencies provided from the first wireless communication circuit 371 may be effectively radiated through the radiator having an adjusted electrical length.

FIG. 12C is a diagram illustrating an example of an antenna structure including a plurality of tuning units according to various embodiments.

Referring to FIG. 12C, in some regions around a side surface member 310 operating as an antenna radiator of the electronic device 300 according to an embodiment, a first tuning unit 361 and a second tuning unit 362 may be disposed. According to an embodiment, a first wireless communication circuit 371 and a second wireless communication circuit 372 may be electrically connected to the side surface member 310 operating as an antenna radiator of the electronic device 300. In FIG. 12C, the first wireless communication circuit 371 and the second wireless communication circuit 372 may be connected to a first conductive portion 311, and a ground point 16 may be formed between a position at which the first wireless communication circuit 371 is connected to the first conductive portion 311 and a position at which the second wireless communication circuit 372 is connected to the first conductive portion 312. In addition, for example, the ground point 16 may be connected to a printed circuit board within the electronic device 300 and/or another component operating as ground.

For example, the first tuning unit 361 may be disposed around a second non-conductive portion 314 and may be electrically connected to the first conductive portion 311 and the second conductive portion 312. For example, the second tuning unit 362 may be disposed around a first non-conductive portion 313 and may be electrically connected to the first conductive portion 311 and a third conductive portion 315.

For example, the first wireless communication circuit 371 may be connected to the first conductive portion 311 between the second non-conductive portion 314 and the ground point 16 to provide a first RF signal to the first conductive portion 312. For example, the second wireless communication circuit 372 may be connected to the first conductive portion 311 between the first non-conductive portion 313 and the ground point 16 to provide a second RF signal to the first conductive portion 311.

For example, a ground point 12 may be formed on a portion of the second conductive portion 312, and a ground point 14 may be formed on a portion of the third conductive portion 315. In addition, for example, the ground point 12 and the ground point 14 may be connected to a printed circuit board within the electronic device 300 and/or another component operating as ground.

According to an embodiment, a portion 32 of the side surface member 310 between the ground point 12 and the ground point 16 may operate as an antenna radiator. According to an embodiment, by controlling a variable capacitor 21 and switches 22 and 23 in the first tuning unit 361, an electrical length of a radiator including a portion of the first conductive portion 311 (e.g., a portion between the ground point 16 and the second non-conductive portion 314) and a portion of the second conductive portion 312 (e.g., a portion between the second non-conductive portion 314 and the ground point 12) may be adjusted. According to an embodiment, by controlling the variable capacitor 21 and the switches 22 and 23 in the first tuning unit 361, first RF signals of various frequencies provided from the first wireless communication circuit 371 may be effectively radiated through the radiator having an adjusted electrical length.

According to an embodiment, a portion 33 of the side surface member 310 between the ground point 14 and the ground point 16 may operate as an antenna radiator. According to an embodiment, by controlling a variable capacitor 24 and switches 25 and 26 in the second tuning unit 362, an electrical length of a radiator including another portion of the first conductive portion 311 (e.g., a portion between the ground point 16 and the first non-conductive portion 313) and a portion of the third conductive portion 315 (e.g., a portion between the first non-conductive portion 313 and the ground point 14) may be adjusted. According to an embodiment, by controlling the variable capacitor 24 and the switches 25 and 26 in the second tuning unit 362, second RF signals of various frequencies provided from the second wireless communication circuit 372 may be effectively radiated through the radiator having an adjusted electrical length.

FIG. 12D is a diagram illustrating an example of an antenna structure including a plurality of tuning units according to various embodiments.

Referring to FIG. 12D, in some regions around the side surface member 310 operating as an antenna radiator of the electronic device 300 according to an embodiment, a first tuning unit 361 and a second tuning unit 362 may be disposed. According to an embodiment, a first wireless communication circuit 371 and a second wireless communication circuit 372 may be electrically connected to the side surface member 310 operating as an antenna radiator of the electronic device 300. In FIG. 12D, the first wireless communication circuit 371 may be connected to the second conductive portion 312, and the second wireless communication circuit 372 may be connected to the third conductive portion 315. For example, a ground point 16 may be formed on the first conductive portion 311 between a portion of the first conductive portion 311 to which the first wireless communication circuit 371 is connected and a portion of the first conductive portion 311 to which the second wireless communication circuit 372 is connected. For example, the ground point 16 may be formed at a position on the first conductive portion 311 closer to the first non-conductive portion 313 than to the second non-conductive portion 314. Accordingly, the length from the first non-conductive portion 313 to a position at which the ground point 16 is formed may be shorter than the length from the second non-conductive portion 314 to the position at which the ground point 16 is formed. In addition, for example, the ground point 16 may be connected to a printed circuit board within the electronic device 300 and/or another component operating as ground.

For example, the first tuning unit 361 may be disposed around the second non-conductive portion 314 and may be electrically connected to the first conductive portion 311 and the second conductive portion 312. For example, the second tuning unit 362 may be disposed around a first non-conductive portion 313 and may be electrically connected to the first conductive portion 311 and a third conductive portion 315.

For example, the first wireless communication circuit 371 may be connected to the second conductive portion 312 to provide a first RF signal to the second conductive portion 312. For example, the second wireless communication circuit 372 may be connected to the third conductive portion 315 to provide a second RF signal to the third conductive portion 315.

For example, a ground point 12 may be formed on a portion of the second conductive portion 312. For example, the ground point 12 may be connected to a printed circuit board within the electronic device 300 and/or another component operating as ground. In addition, for example, the third conductive portion 315 may be electrically isolated from a fourth conductive portion 317 by a third non-conductive portion 316.

According to an embodiment, a portion 34 of the side surface member 310 between the ground point 12 and the ground point 16 may operate as an antenna radiator. According to an embodiment, by controlling a variable capacitor 21 and switches 22 and 23 in the first tuning unit 361, an electrical length of a radiator including a portion of the first conductive portion 311 (e.g., a portion between the second non-conductive portion 314 and the ground point 16) and a portion of the second conductive portion 312 (e.g., a portion between the second non-conductive portion 314 and the ground point 12) may be adjusted. According to an embodiment, by controlling the variable capacitor 21 and the switches 22 and 23 in the first tuning unit 361, first RF signals of various frequencies provided from the first wireless communication circuit 371 may be effectively radiated through the radiator having an adjusted electrical length.

According to an embodiment, a portion 35 of the side surface member 310 between the ground point 16 and the third non-conductive portion 316 may operate as an antenna radiator. According to an embodiment, by controlling the variable capacitor 24 and the switches 25 and 26 in the second tuning unit 362, an electrical length of a radiator including another portion of the first conductive portion 311 (e.g., a portion between the first non-conductive portion 313 and the ground point 16) and the third conductive portion 315 may be adjusted. According to an embodiment, by controlling the variable capacitor 24 and the switches 25 and 26 in the second tuning unit 362, second RF signals of various frequencies provided from the second wireless communication circuit 372 may be effectively radiated through the radiator having an adjusted electrical length.

In FIGS. 12A to 12D, the first tuning unit 361 and the second tuning unit 362 are illustrated as being formed in a structure corresponding to the tuning unit 320 of FIG. 3 and connected to the side surface member 310, however, the disclosure is not limited thereto. For example, the first tuning unit 361 may be the tuning unit 420 of FIG. 4, FIG. 6, or FIG. 7, and the first tuning unit 361 may be connected to the side surface member 310 as illustrated in FIG. 4, FIG. 6, or FIG. 7. Alternatively, for example, the first tuning unit 361 may be the tuning unit 820 of FIG. 8 and may be connected to the side surface member 310 as illustrated in FIG. 8.

According to an example embodiment, an electronic device 101 may include a front surface plate (e.g., 202) facing a front side of the electronic device, a rear surface plate (e.g., 211) facing a rear side of the electronic device, a side surface member (e.g., 218, 310) disposed between the front surface plate and the rear surface plate, the side surface member including a first conductive portion (e.g., 311), a second conductive portion (e.g., 312), and a non-conductive portion (e.g., 314) disposed between the first conductive portion and the second conductive portion, a wireless communication circuit (e.g., 340) electrically connected to the first conductive portion and configured to provide an RF signal of a predetermined frequency, and a first tuning unit (e.g., 320) electrically connected to the first conductive portion and the second conductive portion.

According to an example embodiment, the first tuning unit may include a variable capacitor 321 electrically connected to the first conductive portion and the second conductive portion, and a plurality of switches (e.g., 322, 323) configured to switch an electrical connection between opposite ends of the variable capacitor and at least one lumped element, and as the capacitance of the variable capacitor is adjusted, the length of the radiator including the first conductive portion and the second conductive portion and configured to radiate the RF signal may be adjusted.

According to an example embodiment, one end of the variable capacitor may be electrically connected to the first conductive portion through a first capacitor (e.g., 331) connected to the one end of the variable capacitor via a first switch (e.g., 322) among the plurality of switches.

According to an example embodiment, the other end of the variable capacitor may be electrically connected to the second conductive portion through a second capacitor (e.g., 332) connected to the other end of the variable capacitor via a second switch 323 among the plurality of switches.

According to an example embodiment, by controlling the first switch, the second switch, and the variable capacitor, the length of the radiator including the first conductive portion and the second conductive portion configured to radiate the RF signal may be adjusted.

According to an example embodiment, a third capacitor (e.g., 631, 633) connected in parallel with the first capacitor may be disposed between the one end of the variable capacitor and the first conductive portion, and a fourth capacitor (e.g., 632, 634) connected in parallel with the second capacitor may be disposed between the other end of the variable capacitor and the second conductive portion.

According to an example embodiment, a third switch (e.g., 421, 423) among the plurality of switches may be disposed between the one end of the variable capacitor and the third capacitor, and a fourth switch (e.g., 422, 424) among the plurality of switches may be disposed between the other end of the variable capacitor and the fourth capacitor.

According to an example embodiment, by controlling the first switch, the second switch, the third switch, the fourth switch, and the variable capacitor, the length of the radiator including the first conductive portion and the second conductive portion and configured to radiate the RF signal may be adjusted.

According to an example embodiment, a fifth switch (e.g., 425) configured to switch a connection between the one end and the other end may be disposed between the one end and the other end of the variable capacitor.

According to an example embodiment, by controlling the first switch, the second switch, the third switch, the fourth switch, and the fifth switch, the length of the radiator including the first conductive portion and the second conductive portion and configured to radiate the RF signal may be adjusted.

According to an example embodiment, the one end of the variable capacitor may be connected to the first conductive portion through at least one electronic element (e.g., 72) configured to protect the tuning unit, and the other end of the variable capacitor may be connected to the second conductive portion through at least one electronic element (e.g., 73) configured to protect the tuning unit.

According to an example embodiment, the tuning unit may be formed as an integrated circuit (IC) chip (e.g., 420), and the IC chip may be disposed near the non-conductive portion.

According to an example embodiment, the side surface member may include a third conductive portion 315 and another non-conductive portion 313 disposed between the first conductive portion and the third conductive portion, and the electronic device may further include a second tuning unit 362 electrically connected to the third conductive portion and the first conductive portion.

According to an example embodiment, the second tuning unit may include another variable capacitor electrically connected to the third conductive portion and the first conductive portion, and another plurality of switches configured to switch an electrical connection between opposite ends of the other variable capacitor and at least one lumped element.

According to an example embodiment, as a capacitance of the variable capacitor and a capacitance of the other variable capacitor are adjusted, a length of a radiator including the first conductive portion, the second conductive portion, and the third conductive portion and configured to radiate the RF signal may be adjusted.

According to an example embodiment, one end of the first conductive portion may be connected to the first tuning unit.

According to an example embodiment, the other end of the first conductive portion may be connected to the second tuning unit.

The electronic device according to various embodiments may be one of various types of electronic devices. The electronic devices may include, for example, a portable communication device (e.g., a smartphone), a computer device, a portable multimedia device, a portable medical device, a camera, a wearable device, a home appliance, or the like. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), the element may be coupled with the other element directly (e.g., wiredly), wirelessly, or via a third element. As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Wherein, the “non-transitory” storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server. According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

While the disclosure has been illustrated and described with reference to various example embodiments, it will be understood that the various example embodiments are intended to be illustrative, not limiting. It will be further understood by those skilled in the art that various modifications, alternatives and/or variations of the various example embodiments may be made without departing from the true technical spirit and full technical scope of the disclosure, including the appended claims and their equivalents. It will also be understood that any of the embodiment(s) described herein may be used in conjunction with any other embodiment(s) described herein.

What is claimed is:

1. An electronic device comprising:
a front surface plate facing a front side of the electronic device;
a rear surface plate facing a rear side of the electronic device;
a side surface member comprising a conductive material disposed between the front surface plate and the rear surface plate, the side surface member including a first conductive portion, a second conductive portion, and a non-conductive portion disposed between the first conductive portion and the second conductive portion;
a wireless communication circuit electrically connected to the first conductive portion and configured to provide an RF signal of a specified frequency; and
a first tuning unit electrically connected to the first conductive portion and the second conductive portion,
wherein the first tuning unit comprises:
a variable capacitor electrically connected to the first conductive portion and the second conductive portion, and
a plurality of switches configured to switch an electrical connection between opposite ends of the variable capacitor and at least one lumped element comprising circuitry, and
wherein, based on a capacitance of the variable capacitor being adjusted, a length of a radiator including the first conductive portion and the second conductive portion and configured to radiate the RF signal is configured to be adjusted.

2. The electronic device of claim 1, wherein one end of the variable capacitor is electrically connected to the first conductive portion through a first capacitor connected between the one end of the variable capacitor and a first switch among the plurality of switches, and
wherein another end of the variable capacitor is electrically connected to the second conductive portion through a second capacitor connected between the other end of the variable capacitor and a second switch among the plurality of switches.

3. The electronic device of claim 2, wherein, based on controlling the first switch, the second switch, and the variable capacitor, the length of the radiator including the first conductive portion and the second conductive portion and configured to radiate the RF signal is configured to be adjusted.

4. The electronic device of claim 2, wherein a third capacitor connected in parallel with the first capacitor is disposed between the one end of the variable capacitor and the first conductive portion, and
wherein a fourth capacitor connected in parallel with the second capacitor is disposed between the other end of the variable capacitor and the second conductive portion.

5. The electronic device of claim 4, wherein a third switch among the plurality of switches is disposed between the one end of the variable capacitor and the third capacitor, and
wherein a fourth switch among the plurality of switches is disposed between the other end of the variable capacitor and the fourth capacitor.

6. The electronic device of claim 5, wherein the length of the radiator including the first conductive portion and the second conductive portion and configured to radiate the RF signal is configured to be adjusted based on controlling the first switch, the second switch, the third switch, the fourth switch, and the variable capacitor.

7. The electronic device of claim 2, wherein a fifth switch configured to switch a connection between the one end and the other end of the variable capacitor is disposed between the one end and the other end of the variable capacitor.

8. The electronic device of claim 7, wherein the length of the radiator including the first conductive portion and the second conductive portion and configured to radiate the RF signal is configured to be adjusted based on controlling the first switch, the second switch, the third switch, the fourth switch, and the fifth switch.

9. The electronic device of claim 2, wherein the one end of the variable capacitor is connected to the first conductive portion through at least one electronic element configured to protect the tuning unit, and
wherein the other end of the variable capacitor is connected to the second conductive portion through at least one electronic element configured to protect the tuning unit.

10. The electronic device of claim 1, wherein the tuning unit comprises as an integrated circuit (IC) chip, and the IC chip is disposed adjacent to the non-conductive portion.

11. The electronic device of claim 1, wherein the side surface member includes a third conductive portion and another non-conductive portion disposed between the first conductive portion and the third conductive portion, and
wherein the electronic device further comprises a second tuning unit comprising circuitry electrically connected to the third conductive portion and the first conductive portion.

12. The electronic device of claim 11, wherein the second tuning unit further comprises:
another variable capacitor electrically connected to the third conductive portion and the first conductive portion; and
another plurality of switches configured to switch an electrical connection between opposite ends of the other variable capacitor and at least one lumped element.

13. The electronic device of claim 12, wherein, based on a capacitance of the variable capacitor and a capacitance of the other variable capacitor being adjusted, a length of a radiator including the first conductive portion, the second conductive portion, and the third conductive portion and configured to radiate the RF signal is configured to be adjusted.

14. The electronic device of claim 11, wherein one end of the first conductive portion is connected to the first tuning unit.

15. The electronic device of claim 14, wherein another end of the first conductive portion is connected to the second tuning unit.

16. An electronic device comprising:
a front surface plate facing a front side of the electronic device;
a rear surface plate facing a rear side of the electronic device;
a side surface member comprising a conductive material disposed between the front surface plate and the rear surface plate, the side surface member including a first conductive portion, a second conductive portion, and a non-conductive portion disposed between the first conductive portion and the second conductive portion;
a wireless communication circuit electrically connected to the first conductive portion and configured to provide an RF signal of a specified frequency; and
a first tuning unit electrically connected to the first conductive portion and the second conductive portion,
wherein the first tuning unit comprises:
a variable capacitor electrically connected to the first conductive portion and the second conductive portion, and
a plurality of switches configured to switch an electrical connection between opposite ends of the variable capacitor and at least one lumped element comprising circuitry, and
wherein one end of the variable capacitor is electrically connected to the first conductive portion through a first capacitor connected between the one end of the variable capacitor and a first switch among the plurality of switches, and
wherein another end of the variable capacitor is electrically connected to the second conductive portion through a second capacitor connected between the other end of the variable capacitor and a second switch among the plurality of switches

17. The electronic device of claim 16, wherein, based on controlling the first switch, the second switch, and the variable capacitor, the length of the radiator including the first conductive portion and the second conductive portion and configured to radiate the RF signal is configured to be adjusted.

18. The electronic device of claim 16, wherein a third capacitor connected in parallel with the first capacitor is disposed between the one end of the variable capacitor and the first conductive portion, and
wherein a fourth capacitor connected in parallel with the second capacitor is disposed between the other end of the variable capacitor and the second conductive portion.

19. The electronic device of claim 18, wherein a third switch among the plurality of switches is disposed between the one end of the variable capacitor and the third capacitor, and
wherein a fourth switch among the plurality of switches is disposed between the other end of the variable capacitor and the fourth capacitor.

20. The electronic device of claim 19, wherein the length of the radiator including the first conductive portion and the second conductive portion and configured to radiate the RF signal is configured to be adjusted based on controlling the first switch, the second switch, the third switch, the fourth switch, and the variable capacitor.
